(19) United States
(12) Patent Application Publication
(10) Pub. No.: US 2016/0239317 A1
(43) Pub. Date: Aug. 18, 2016

(54) Method and Apparatus for Application Management and Control

(71) Applicant: Ford Global Technologies, LLC, Dearborn, MI (US)

(72) Inventors: Mark A. Cuddihy, New Boston, MI (US); Manoharprasad K. Rao, Novi, MI (US); Kwaku O. Prakah-Asante, Commerce Township, MI (US)

(21) Appl. No.: 14/623,686

(22) Filed: Feb. 17, 2015

(51) Int. Cl. G06F 9/445; B60K 35/00

(52) U.S. Cl. CPC G06F 9/44526; B60K 35/00

(57) ABSTRACT

A system includes a processor configured to load a dashboard application including control over a secondary application. The processor is also configured to determine, via the dashboard application, a condition associated with the launch of the secondary application. Further, the processor is configured to determine if the condition has occurred and, upon occurrence of the condition, instruct launch of the secondary application from the dashboard application.

### TECHNICAL FIELD

The illustrative embodiments generally relate to a method and apparatus for application management and control.

### BACKGROUND

Automotive-related smart phone applications have become increasingly popular with the car-buying public, as vehicle telematics and infotainment systems continue to advance. Automotive companies have provided application programming interfaces (APIs) that allow programmers and developers to create applications that can access the inputs and outputs of a vehicle, and leverage vehicle data to further the goals of particular applications. Hundreds of automotive-related applications are currently available, including, but not limited to, fuel related applications, augmented navigation applications, driving assistance applications, communication management applications, media provision applications and even advertising applications.

As with smart phone applications, a given driver may have a large number of automotive related applications downloaded to a vehicle or provided by a device in communication with a vehicle. Some may be useful in only certain conditions, others the driver may wish to utilize on every drive. Managing the applications can be difficult and distracting while a vehicle is in motion. Further, it can be a hassle to select and launch every needed/desired application each time the vehicle is started. Some applications may even provide increased safety, but it may be inadvisable for the driver to attempt to launch these applications when a condition which the application addresses occurs.

One solution to application management includes a system and method for providing application objects on a mobile computing device. The method comprises automatically determining one or more categories for newly installed applications. Application meta-information about a library of installed applications, including meta-information associated with the newly installed applications, is maintained. The meta-information also includes category information. The method further comprises providing an application launch interface that presents selectable objects of individual applications that comprise the library of installed applications. Providing the application launch interface includes automatically organizing the selectable objects of individual applications by category, so that the selectable objects are displayed by category.

### SUMMARY

In a first illustrative embodiment, a system includes a processor configured to load a dashboard application including control over a secondary application. The processor is also configured to determine, via the dashboard application, a condition associated with the launch of the secondary application. Further, the processor is configured to determine if the condition has occurred and, upon occurrence of the condition, instruct launch of the secondary application from the dashboard application.

In a second illustrative embodiment, a computer-implemented method includes loading a dashboard application including control over a secondary application. The method also includes determining, via the dashboard application, a condition associated with the launch of the secondary application. Further, the method includes determining if the condition has occurred and upon occurrence of the condition, instructing launch of the secondary application from the dashboard application.

In a third illustrative embodiment, a non-transitory computer-readable storage medium stores instructions that, when executed, cause a processor to perform a computer-implemented method including loading a dashboard application including control over a secondary application. The method also includes determining, via the dashboard application, a condition associated with the launch of the secondary application. Further, the method includes determining if the condition has occurred and, upon occurrence of the condition, instructing launch of the secondary application from the dashboard application.

### BRIEF DESCRIPTION OF THE DRAWINGS

FIG. 1 shows an illustrative vehicle computing system;

FIG. 2 shows an illustrative example of a dashboard initiation process;

FIG. 3 shows an illustrative example of an application control process;

FIG. 4 shows an illustrative example of an application addition/removal process;

FIG. 5 shows an illustrative example of an application launch process; and

FIG. 6 shows an illustrative dashboard application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

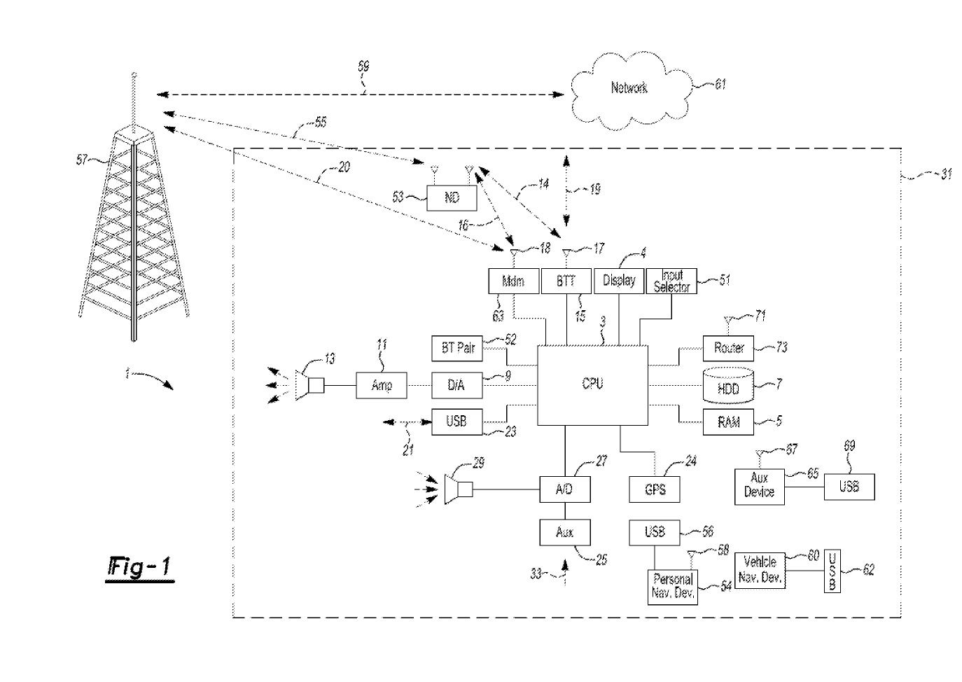

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

While various solutions have been developed to aid in application management, the illustrative embodiments provide an improved application and environment for presentation, initiation, ending, and management of multiple vehicle related applications. The applications are controlled based on observed user preferences and certain of the applications can be launched when appropriate, to the extent those applications rely on the occurrence of various vehicle or environmental states. For example, without limitation, the user may always want a media player application launched upon vehicle start up, as well as an application that provides enhanced navigation. The user may also have a cheap fuel finding application that the user wants checked whenever in proximity to a refueling point or if fuel is low. The user may further have a call handling application that the user wants launched if there is heavy weather or other driving conditions that may make communication undesirable.

Utilizing the illustrative embodiments, the controlling application (called a dash-board application) can handle the engagement and termination of various applications as needed. Further, if the user frequently uses a new application, or uses a new application (not currently part of the dashboard) in conjunction with observable conditions, the system can learn to include that application and/or launch that application under the appropriate conditions. In this manner, the illustrative embodiments are adaptive to changing user desires, and can help provide an enhanced driving experience.

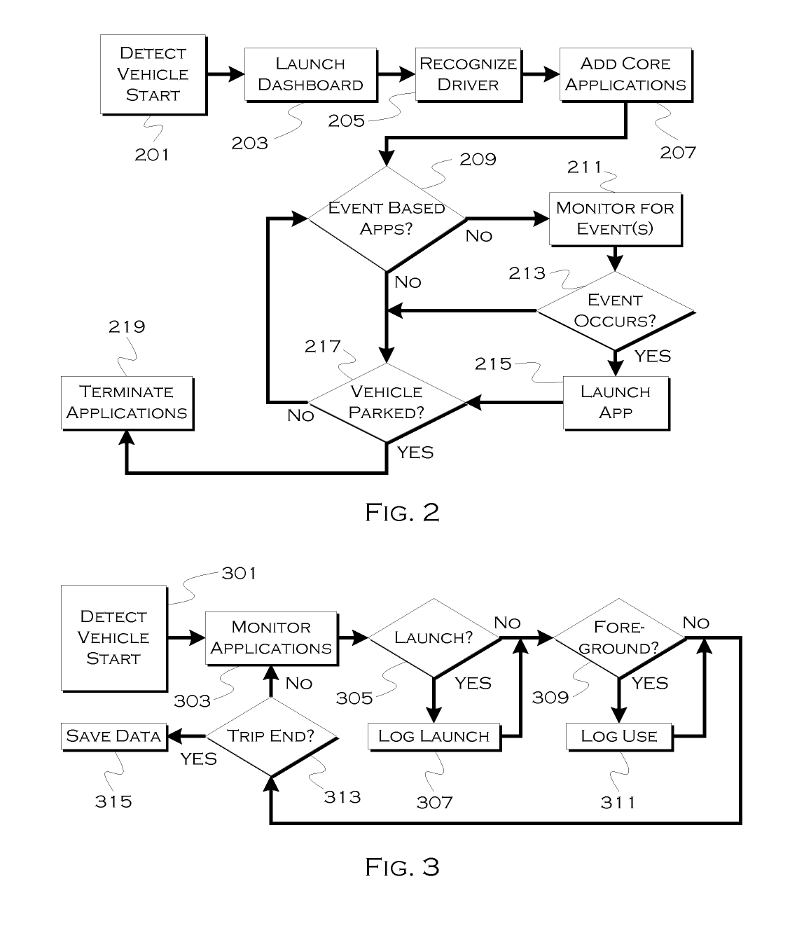

FIG. 2 shows an illustrative example of a dashboard initiation process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process first detects a vehicle initialization 201. Typically, although not necessarily, this may correspond to a vehicle start. But, for example, if the vehicle is remotely started, this may instead be the detecting of a vehicle entry event. The “initial” point at which applications are launched can be managed to avoid launching applications while the user is still in a house, for example. In conjunction with the initialization, the process includes launching a vehicle dashboard application to handle the other applications 203.

The dashboard application will either be launched in conjunction with a driver profile, or has other ways of recognizing a particular driver 205. For example, the application, if run on a vehicle, could recognize a driver phone or wearable device. Since different drivers may have different application preferences, the dashboard application will add core applications (previously identified) based on the recognized driver to a conglomerate of applications the driver might want access to 207. Some number of these applications may also be launched upon initialization, if, for example, they are applications that correspond to applications the driver wants constantly engaged (i.e., applications the driver would manually launch every time or most times in the absence of the dashboard application).

In addition to the persistent applications described above, the applications may include some number of state or condition based applications that launch (or would be launched by a driver) when certain conditions occur 209. Either based on observed driver behavior or conditions pre-associated with these applications (e.g., low fuel condition, rain/snow, etc.), these applications can be launched when the various states/conditions occur.

If there are condition based applications present in the dashboard application, the process will monitor for the occurrence of the various conditions 211 and, if the specified event/condition occurs 213, the process can launch the application 215. Checking for event based applications (since some may be added during the journey) and monitoring for the occurrence of events can continue until the vehicle is placed in a park state 217. At this point, the applications can be terminated 219. This also helps avoid having to have the driver terminate applications running on a mobile device in communication with the vehicle, so that battery life is preserved. Applications can also be automatically terminated based on the ending of the various trigger states or conditions (e.g., it stops snowing, the driver refuels, etc.). By using the dashboard application to automatically engage and terminate applications, the driver attention can be focused on the road. Because the dashboard application can dynamically learn engagement/termination conditions as well as add and remove applications, the driver may not need to spend too much time actually setting up the dashboard application if the driver does not want to bother.

FIG. 3 shows an illustrative example of an application control process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process again detects a vehicle start condition 301. Here, new applications that are not currently on the dashboard application, as well as applications that are a part of the dashboard application, are monitored 303 to determine if applications should be added or removed from the dashboard application (a later described process). In this example, the process detects each time an application (whether or not the application is part of the dashboard application) is launched 305, and logs data relating to the launch 307. The launch-related data can include, but is not limited to, time of launch, vehicle state(s), environmental state(s), driver distraction level(s), duration of use, etc. Also, in this example, whether or not the application is ever placed in the foreground 309 is monitored.

An application is typically in the foreground when a user is interacting with the application or the application is in active control of a system. For example, some older application may be automatically launched every time a vehicle is started, but never actually used by the user during a trip. The launch may be based on old preferences, a newer preferred application may have supplanted the old application. Thus, if the application launches were logged alone, the application may appear to receive heavy usage. In this example, by logging the foreground instances as well, it is possible to further determine if the application is receiving actual use, or is just being launched. Of course, mere launching can also be monitored alone in a useful manner if a less sophisticated system is desired, or if the foreground monitoring creates other problems. The monitoring in this example persists until the trip ends 313, at which point the logged data is saved 315. The data may be saved locally on the vehicle, saved on a wirelessly connected device and/or uploaded to a remote server for processing and/or analysis.

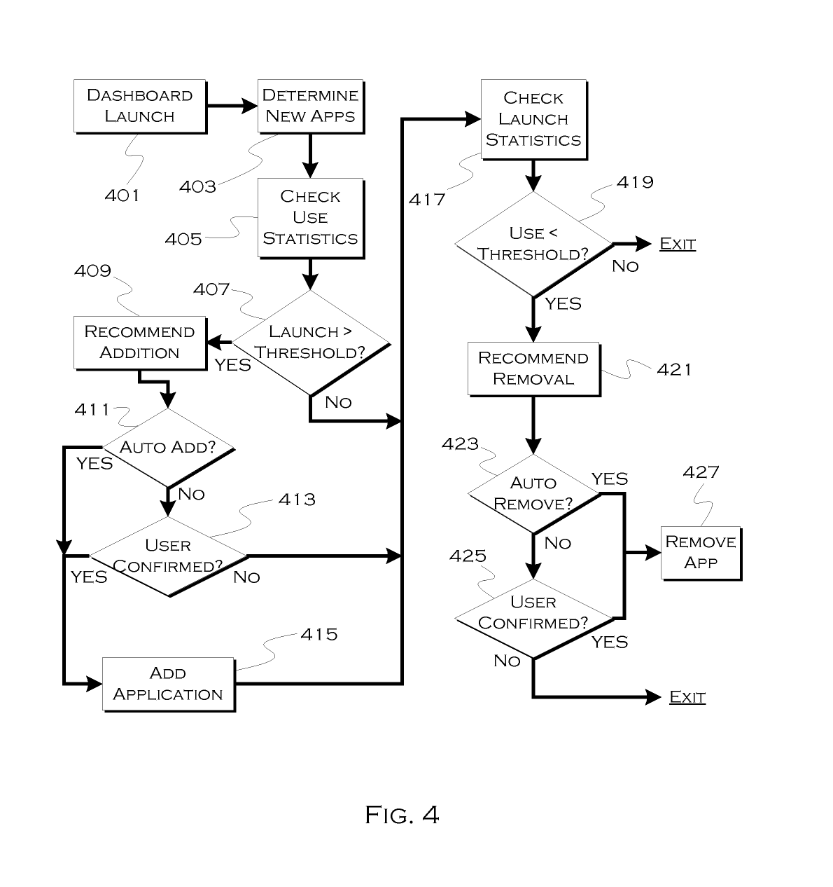

FIG. 4 shows an illustrative example of an application addition/removal process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process will attempt to add new applications to the dashboard application in a dynamic and automatic manner and remove unused applications from the dashboard application. In this example, the process first launches the dashboard application 401.

Once the dashboard application is launched, the process will examine any new applications whose use has been logged (and/or which have had foreground usage) 403. In one example, this could correspond to any user initiated application launches, for example, of any applications during a previous journey or since a previous update process had been run.

For each newly utilized application, the process may check the launch/foreground statistics 405. These logs of applications launch and/or usage may indicate how frequently the application was launched, whether or not the application launch was in conjunction with noted conditionals, how frequently the application was used after launch, etc. If the launch statistics demonstrate the application was used more than a threshold amount 407, the process may recommend addition of the application to the dashboard application as a dashboard application 409.

In some instances, the threshold may be based on the number of times or percentage of times the application was launched. In other instances, such as with conditional applications, the threshold may be based on the number or percentage of times the application was launched when the condition occurred. The process could attempt to dynamically determine the condition(s) for launch (which may require some minimum data set) or the user could indicate a basis for launch in relationship to an application (in response to a query, for example).

Once the process has recommended addition of the application, the process checks to see if automatic application addition is enabled 411. In automatic addition, any application meeting the set thresholds will be automatically added and the launch sequence (e.g., upon startup, upon condition, etc.) can be set automatically as well. If the automatic addition is not enabled, the process will wait for user confirmation 413 to add the application to the dashboard application 415. As a part of the user confirmation (and possible even if automatic addition is utilized), the process may have a user configure the application so that the dashboard application knows when to launch the application. This could be resolved at a point when a vehicle is not moving, for example, and/or could be resolved via one or more simple configuration menus or queries.

In addition to checking for applications that should be added, the illustrative process checks for applications that should be removed from the dashboard application. In this example, the process checks use statistics for all applications presently a part of the dashboard application 417. If the use or launch of an application is below a removal threshold 419, the process may recommend removal of the application 421. The removal threshold may be the same or different from the addition threshold. Further, as with addition, usage or launch statistics for conditional applications may be considered with respect to the number of occurrences of the particular conditions for launch, as opposed to with respect to every journey.

If the application meets the standard for removal, and removal is recommended, the process may check to see if automatic removal is enabled 423. As with automatic addition, this will automatically change the status (in this case remove) of non-qualifying applications. Otherwise, user confirmation may be requested 425 before application removal 427 is processed.

By allowing the dashboard application process to track usage of present dashboard applications and new applications, the array of options on the dashboard can be kept fairly up to date in accordance with applications actually desired by a user.

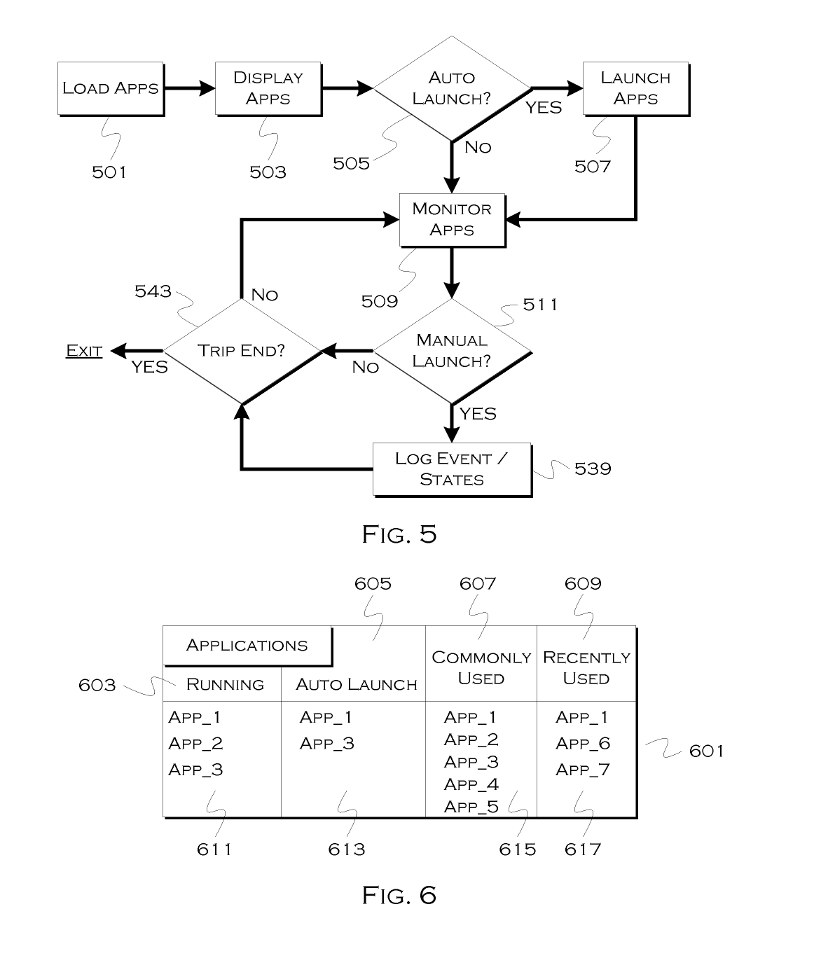

FIG. 5 shows an illustrative example of an application launch process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process will attempt to track some set of states related to application launch and/or usage. The dashboard application will load all known dashboard application related applications 501 and display them 503 for user selection (in the event that they are not all automatically launched, for example). If any of the applications are to be automatically launched, based on states or the vehicle startup 505, the process can launch those applications at the appropriate times 507.

Additionally, the process will monitor launched applications 509 and applications that a user may utilize or initiate. If there is a manual launch of an application 511 (either from the dashboard application or from a menu of applications), the process can record a set of states/events/conditions associated with the launch or use of the particular application 513. This will help develop a better data set for determining appropriate conditions for launch. For example, without limitation, the process may display a fuel-finder as a part of a dashboard application. This application may have been triggered to launch based on a fuel state below 20% based on previous data.

As time progresses, the data logged may indicate that the application is actually launched by a user whenever fuel is below a 25% mark. Thus, the application can shift automatic engagement to reflect the new 25% threshold, and thereby result in automatic engagement at an earlier point. Until the trip ends 515, this sort of statistic and state information gathering can occur.

FIG. 6 shows an illustrative dashboard application. This is a non-limiting example of what a dashboard application may display, and is provided for illustrative purposes only. This sort of dashboard application could be shown on an in-vehicle display, for example, or on a mobile device in communication with the vehicle.

In this example, the dashboard application 601 includes several categories for various applications. These include, in this example, running applications 603, automatically launched applications 605, commonly used applications 607 and recently used applications 609. In one example, a drag and drop interface can be used that allows a user to easily move an application into or out of a field. If an application is manually added to auto-launch, for example, a secondary process for setting the conditions for launch may be initiated.

Here, applications 1, 2 and 3 are currently running on the vehicle 611. Applications 1 and 3 are configured to automatically launch 613, so the conditions for their launch would have been respectively met. Commonly used applications 1-5 615 are easily selectable and launchable from the dashboard application without the user having to scroll through a menu of undesired or unrelated applications. Recently used applications 1, 6 and 7 617 are also selectable here, in case the user wants to add them to the commonly used menu or an auto-launch menu, for example.

By providing a management tool for the use of applications, and by automatically starting, ending, adding and removing applications, the dashboard application can streamline the user experience, and encourage more application usage which should help further improve a driver experience.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a processor configured to:
load a dashboard application including control over a secondary application;
determine, via the dashboard application, a vehicle-state condition associated with a launch of the secondary application;
determine if the condition has occurred; and
upon occurrence of the condition, instruct launch of the secondary application from the dashboard application.

2. The system of claim 1, wherein processor is further configured to log instances of application usage, via the dashboard application, for a tertiary application not presently associated with the dashboard application.

3. The system of claim 2, wherein the processor is further configured to associate the tertiary application with the dashboard application as the secondary application when logged usage exceeds a predetermined threshold.

4. The system of claim 3, wherein the logged usage is based on launches of the application and the threshold is based on an aggregate number of launches.

5. The system of claim 3, wherein the logged usage is based on utilization of a launched application and the threshold is based on an aggregate number of utilization instances.

6. The system of claim 3, wherein the logged usage includes a conditional associated with the usage, and the threshold is determined based on occurrences of the conditional.

7. The system of claim 1, wherein the processor is further configured to track, via the dashboard application, trips during which the secondary application was not utilized and to recommend removal of the secondary application from association with the dashboard application if utilization of the secondary application falls below a predetermined threshold.

8. The system of claim 7, wherein utilization includes application launch.

9. The system of claim 7, wherein utilization includes active use of a launched application.

10. A computer-implemented method comprising:
loading a dashboard application including control over a secondary application;
determining, via the dashboard application, an environmental-state condition associated with a launch of the secondary application;
determining if the condition has occurred; and
upon occurrence of the condition, instructing launch of the secondary application from the dashboard application.

11. The method of claim 10, further comprising: logging instances of application usage, via the dashboard application, for a tertiary application not presently associated with the dashboard application.

12. The method of claim 11, further comprising associating the tertiary application with the dashboard application as the secondary application when logged usage exceeds a predetermined threshold.

13. The method of claim 12, wherein the logged usage is based on launches of the application and the threshold is based on an aggregate number of launches.

14. The method of claim 12, wherein the logged usage is based on utilization of a launched application and the threshold is based on an aggregate number of utilization instances.

15. The method of claim 12, wherein the logged usage includes a conditional associated with the usage, and the threshold is determined based on occurrences of the conditional.

16. The method of claim 10, further comprising tracking, via the dashboard application, trips during which the secondary application was not utilized and recommending removal of the secondary application from association with the dashboard application if utilization of the secondary application falls below a predetermined threshold.

17. The method of claim 16, wherein utilization includes application launch.

18. The method of claim 16, wherein utilization includes active use of a launched application.

19. A non-transitory computer-readable storage medium, storing instructions that, when executed, cause a processor to perform a computer-implemented method comprising:
loading a dashboard application including control over a secondary application;
determining, via the dashboard application, a driver-state condition associated with a launch of the secondary application;
determining if the condition has occurred; and
upon occurrence of the condition, instructing launch of the secondary application from the dashboard application.

20. The storage medium of claim 19, the method further comprising:
logging instances of application usage, via the dashboard application, for a tertiary application not presently associated with the dashboard application; and
associating the tertiary application with the dashboard application as the secondary application when logged usage exceeds a predetermined threshold.
